(19) United States
(12) Patent Application Publication
(10) Pub. No.: US 2002/0086600 A1
(43) Pub. Date: Jul. 4, 2002

(54) Thermal interface medium

(76) Inventor: Prosenjit Ghosh, Portland, OR (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/751,261

(22) Filed: Dec. 29, 2000

(51) Int. Cl. D03D 15/00; D04H 1/00; B29C 51/42; B29C 67/00

(52) U.S. Cl. 442/229; 442/376; 442/377; 264/316; 264/320; 264/322; 264/324; 425/394

(57) ABSTRACT

A thermal interface material for interfacing with at least a first surface. One embodiment of the thermal interface material includes a plurality of thermally conductive, malleable fibers arranged in a pattern. The fibers contact each other so as to reduce air gaps and fill irregularities when the fibers are compressed against the first surface.

### BACKGROUND OF THE INVENTION

Internal components of electronic devices, such as computers, become heated after a period of use. The increased heat increases heat resistance, resulting in decreased system performance. Performance may be restored or improved by cooling the electrical components using a heat exchanger, a device that transfers heat from a hot body to a cold body via conduction or convection. Conduction refers to the transfer of heat or electricity between different parts of a substance as a result of a difference in the temperature in the case of heat, or as a result of a difference on electric potential, in the case of electricity. The rate of heat flow between two regions is proportional to the temperature difference between them and the heat conductivity of the substance.

Heat may be transferred between two bodies simply by bringing the bodies into contact with each other. Thus in the simplest form, a heat exchanger typically consists of a warm body coupled with a cooler body. However, simply touching two bodies together rarely yields an efficient transfer of heat, as the mating surface of the two bodies often contain irregular ties that create air gaps between the surfaces. Because air does not transfer heat as well as other substances, such as metal, for example, the air gaps reduce the efficiency of heat transfer.

A more efficient means of exchanging heat between two bodies is to insert a thermal interface material between the mating surfaces. The thermal interface material conforms to the irregularities present in each mating surface and improves heat transfer by reducing or eliminating air pockets, Using a thermal interface material is generally less costly then matching the mating surfaces to have mirror-like finishes. Examples of conventional interface materials include thermal greases of gels. Metallic particles are often embedded in the grease or gel to improve the interface material's heat transfer properties. However, the metallic particles suspended in the grease or gel are often separated by spaces occupied by grease or gel. Heat applied to the interface material is transferred through the particles filed gel at different rates, first through a gel filled space and then through a metallic particle or cluster of particles, or vise versa. Because grease or gel transfers heat less efficiently than metal, the thermal transfer rate of the particle/grease combination is limited by the grease filled spaces between the particles.

The present invention provides a material that overcomes several of the problems common in the art using a pattern of thermally conductive, malleable fibers.

### BRIEF DESCRIPTION OF THE DRAWINGS

The present invention is illustrated by way of example and not limitation in the figures of the accompanying drawings, in which

FIG. 1 illustrates the architecture of a conventional heat transfer assembly;

FIGS. 2a-2b illustrate a prior art thermal interface medium;

FIGS. 3a-3b illustrate one embodiment of the thermal interface medium,

FIGS. 4a-4c illustrate one embodiment of a stacked thermal interface medium;

FIGS. 5a-5b illustrate one embodiment of a random thermal interface medium;

FIGS. 6a-6b illustrate one embodiment of a woven thermal interface medium;

### DETAILED DESCRIPTION

A thermal interface medium is disclosed. In the following detailed description, numerous specific details are set forth in order to provide a thorough understanding of the present invention. However, it will be apparent to one of ordinary skill in the art that these specific details need not be used to practice the present invention. In other circumstances, well-known structures, materials, circuits, processes and interfaces have not been shown or described in detail in order not to unnecessarily obscure the present invention.

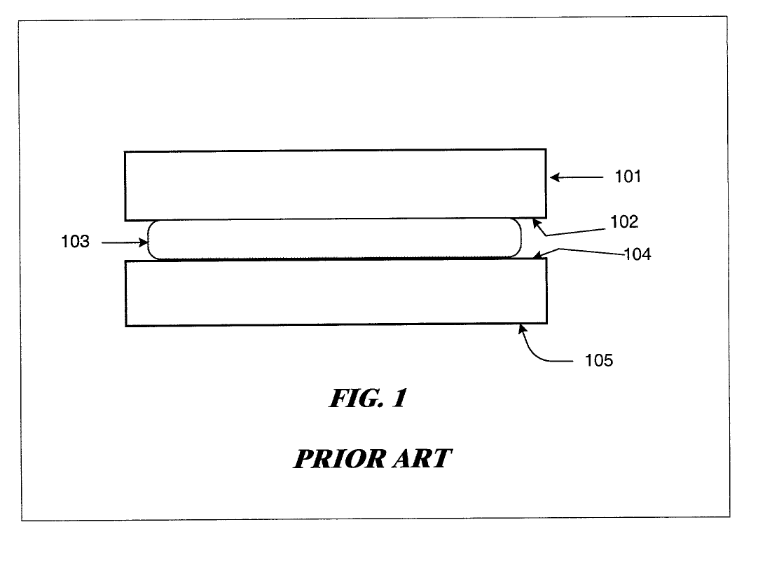

Referring now to FIG. 1, a diagram of a conventional heat transfer assembly is illustrated. Thermal plate 101 is cooled by convection or other cooling means well known in the art so as to have a cooler temperature than heat source 105. In this conventional network architecture, heat source 105 may be an integrated circuit or other electronic element used in the manufacture and operation of an electronic device such as a computer, a personal digital assistant, stereo, or other similar device. The warm or hot temperature of heat source 105 results from the flow of electric current in heat source 105 or results from heat produced by elements coupled with heat source 105. Thermal interface medium 103 is positioned between thermal plate 101 and heat source 105 to allow the efficient transfer of heat from heat source 105 to thermal plate 101. In conventional manufacturing processes, the surface 102 of thermal plate 101 and the surface 104 of heat source 105 contain irregularities. If surface 102 is positioned to contact surface 104 directly, the efficiency of heat transfer between the two bodies is reduced by air gaps caused by the irregularities in the mating surfaces. For this reason, thermal interface medium 103 is provided to thoroughly mate surface 102 with surface 104.

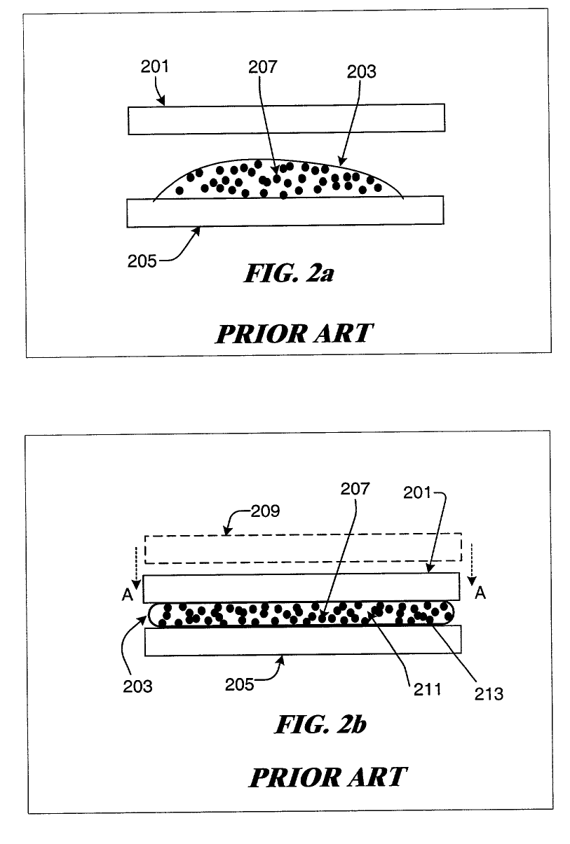

Referring now to FIG. 2, another example of a conventional heat transfer assembly is illustrated. As shown in FIG. 2a, an interface material 203 is coupled with heat source 205 in preparation to mate with thermal plate 201. Conventional interface material 203 is usually a thermal gel or grease having heat transfer properties. Metallic particles are randomly distributed throughout the material to improve its heat transfer properties. When interface material 203 is compressed between thermal plate 201 and heat source 205, as shown in FIG. 2b, a plurality of metallic particles come into contact with each other to form a plurality of discontinuous metallic paths 213. Because metal typically has a higher thermal transfer rate than grease due to the extra free electrons inherent in metal, heat will typically flow more efficiently and quickly along the discontinuous metallic paths 213 than it does through the grease filled spaces 211 between the metallic particles 207. The grease filled spaces 211 limit the thermal transfer rate of the interface material.

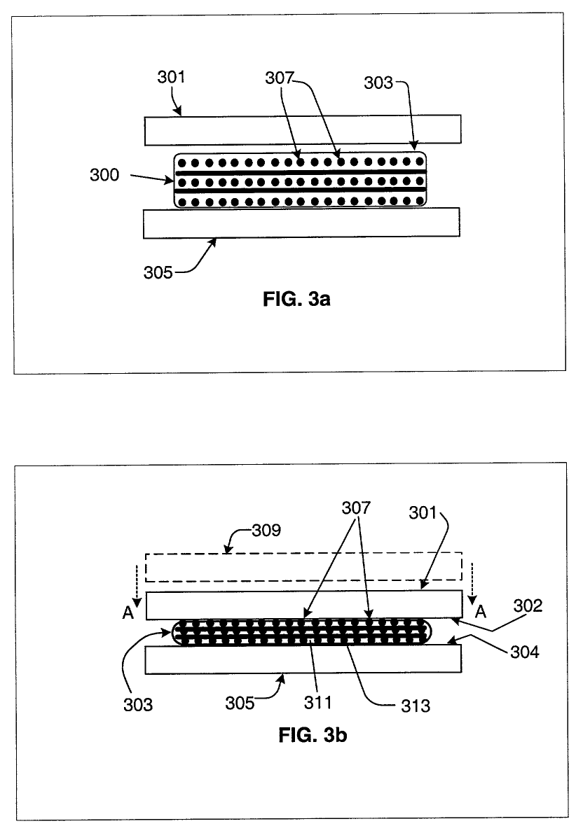

The present invention is used in a heat transfer environment. FIG. 3 illustrates a thermal interface material 300 according to one embodiment. As shown in FIG. 3a, the thermal interface material 300 includes a plurality of thermally conductive, malleable fibers 307 embedded in a grease or gel 303. The material 300 is coupled with heat source 305, in preparation to mate with thermal plate 301. In contrast to the metallic particles shown in FIGS. 1 and 2, the thermally conductive, malleable fibers 307 are generally continuous along their respective lengths. The fibers 307 may be made a metal, a metal alloy, a metal compound, or combinations thereof, such as, for example copper or silver. Alternatively, fibers 307 may be made of a non-metal, such as carbon fiber or graphite. In one embodiment, the architecture illustrated in FIG. 3a may be fashioned of a single fiber.

When compressed by thermal plate 301, as illustrated by the embodiment shown in FIG. 3b, the material 300 deforms, forcing the fibers 307 into substantially continuous or continuous contact with each other, to form substantially continuous or continuous metallic paths that allow efficient heat transfer between heat source 305 and thermal plate 301. Grease filled gaps 311 may still exist, but the number and quality of the thermal transfer connections is improved; and the conformed interface material thermally behaves in unison similar to a one piece material with high thermal properties, without exhibiting the technical issues (thermal stress, CTE, etc.) associated with such a material.

In one embodiment, thermal interface material 300 includes thermally conductive malleable fibers immersed in a suitable medium such as thermal grease or gel. The metallic fibers 307 can be configured in multiple patterns, such as, for example, stacked, random, and woven, Exemplary patterns are described in more detail below. The interface material 300 is sandwiched between surface 304 of heat source 305 and surface 302 of thermal plate 301, and is especially adept to high toleranced stack up assemblies. Once the assembly is secured, the conductive fibers 307 deform and conform to the mating surfaces 302, 304, and contact each other, making continuous or substantially continuous “paths” of metal (or nonmetal) for efficient heat transfer. The grease or gel 303, rather than acting as the primary medium for heat transfer, acts as a supplementary vehicle aiding the conductive fibers by reducing or eliminating voids between the interface material 300 and mating surfaces 302, 304.

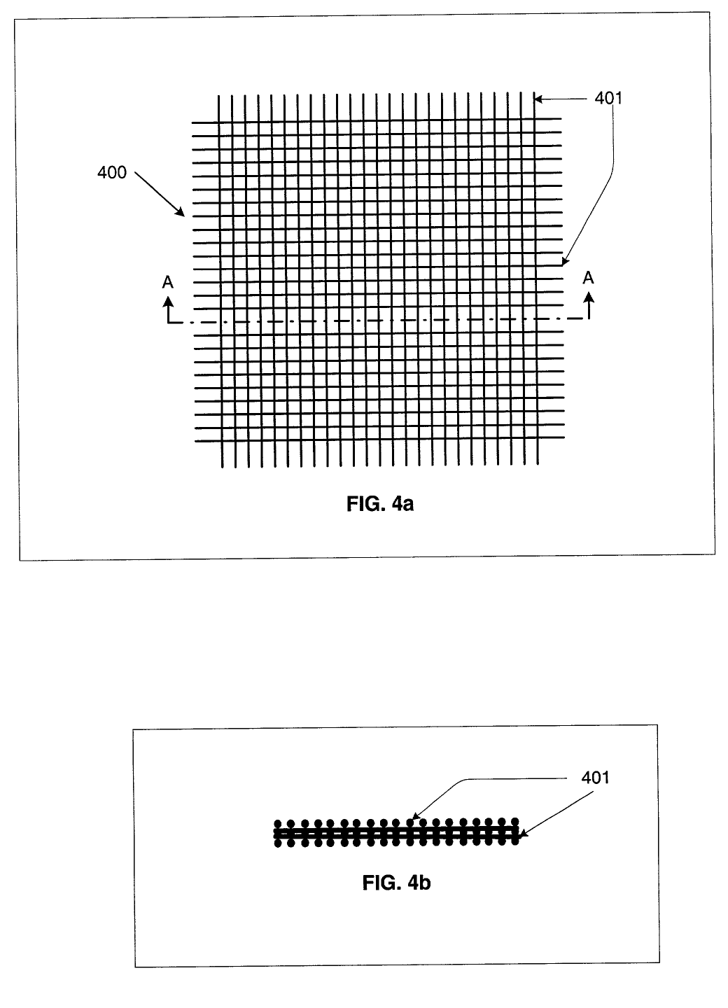

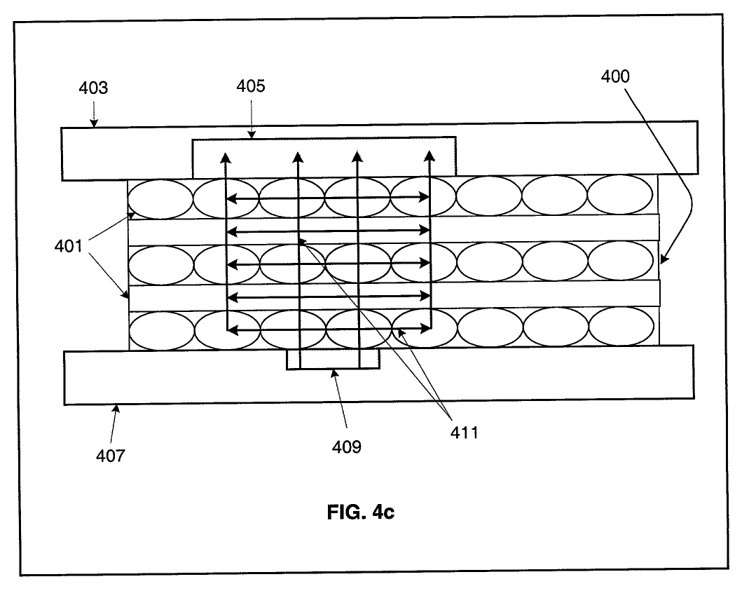

Referring to FIG. 4, a stacked pattern of thermally conductive, malleable fibers is shown. As illustrated in FIG. 4a, stacked pattern 400 is manufactured by layering substantially parallel rows of fibers 401 substantially orthogonally on top of each other to form a grid. The grid includes fibers 401 of a size and spacing appropriate for the particular application. For example, fibers 401 comprising the grid may be microscopic in size, or substantially larger.

Referring to FIG. 4b, a cross sectional view of stacked pattern 400, taken along the direction of arrows A in FIG. 4a, is shown. The fibers rest on each other when deformed, and transfer heat longitudinally and laterally in three dimensions through the interface material.

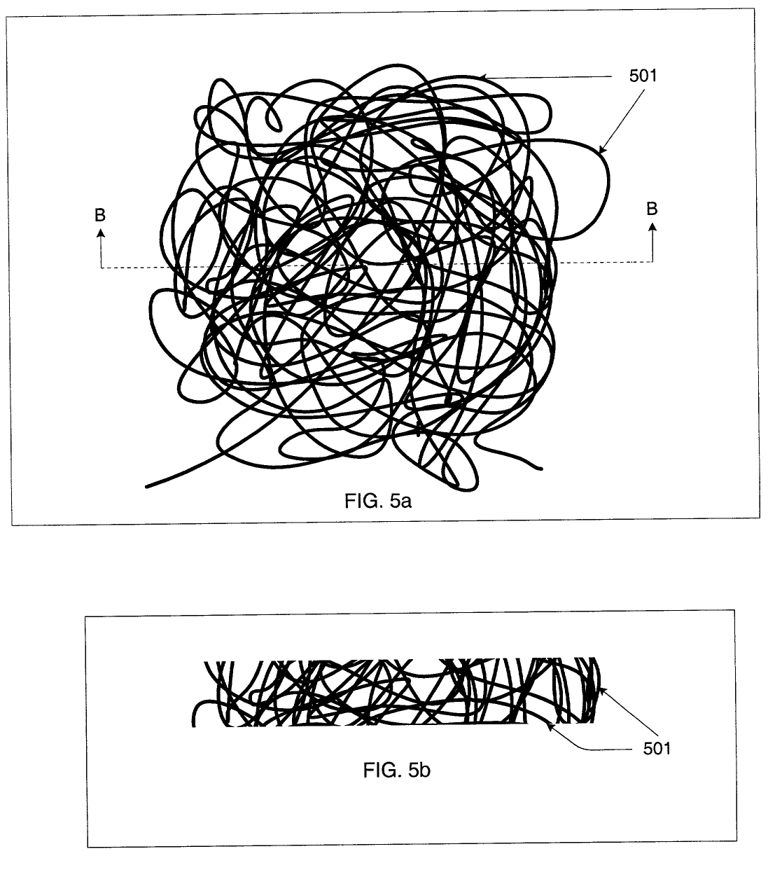

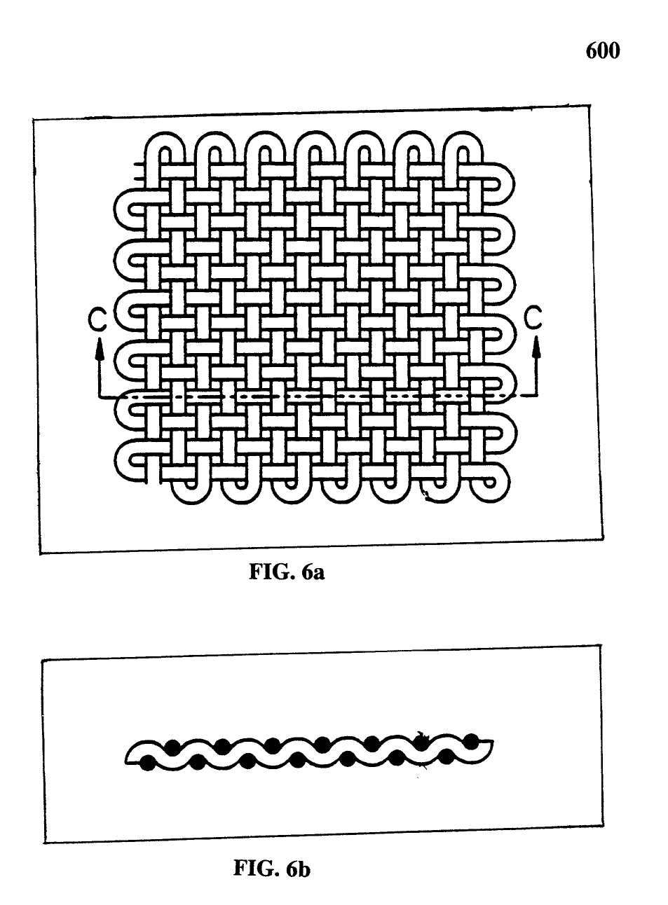

Referring now to FIG. 4c, the lateral and longitudinal distribution of heat in a stacked pattern 400 is illustrated. In this Figure, heat 411 is transferred to pattern 400 from hot section 409 of heat source 407 and, ripples laterally and substantially concentrically outward in three dimensions through the interface material, such that the heat 411 is quickly absorbed by the interface material and transferred to section 405 in thermal plate 403. Section 405 may have a surface area less than or greater than the surface area of section 403. A similar three dimensional transfer of heat occurs with respect to the patterns shown in FIGS. 5 and 6.

Referring to FIG. 5, a random pattern of thermally conductive, malleable fibers is shown. FIG. 5a is an overhead view of random pattern 500, and FIG. 5b is a cross sectional view of woven pattern 500 taken along the direction of arrows B in FIG. 5a. Random pattern 500 illustrated in FIG. 5a and FIG. 5b may be fashioned using a plurality of fibers 501 or from a single fiber tangled together in a random fashion.

In one embodiment, a pattern of fibers may be manufactured in a relatively large sheet or block, and then cut into a plurality of pieces that are individually sized for use in particular applications. The materials comprising the patterns and the pattern configurations may be varied to fit a particular application. The fiber(s) 501 may be manufactured using any one of a number of extruding, injecting, or infusing processes known in the manufacturing arts.

Referring to FIG. 6, a woven pattern of thermally conductive, malleable fibers is illustrated. FIG. 6a is an overhead view of woven pattern 600, and FIG. 6b is a cross sectional view of woven pattern 600 taken along the direction of arrows C in FIG. 6a. Woven pattern 600 may be manufactured using a single fiber 601 or a plurality of fibers. The pattern may be incorporated in a thermal grease or gel, or used without a thermal grease or gel. In one embodiment, an adhesive material, of a type commonly known in the adhesive and manufacturing arts, may be applied to woven pattern 600 or other pattern of thermally conductive, malleable fibers to attach the pattern to a surface in preparation to mate with another surface. For example, the adhesive material may be applied to the pattern of thermally conductive, malleable fibers. The pattern can then be positioned adjacent to a surface and stuck in place. At a later time, the pattern may be compressed by pressure applied to another surface placed adjacent the pattern to deform the pattern and conform it to the mating surfaces. In one embodiment, the pattern may be replaced by removing the old pattern and adhering a new one. At least three illustrative patterns have been shown and described, however, the present invention is not limited to these examples, but includes additional patterns.

Although the present invention is described herein with reference to a specific preferred embodiment, many modifications and variations therein will readily occur to those with ordinary skill in the art. Accordingly, all such variations and modifications are included within the intended scope of the present invention as defined by the following claims.

What is claimed is:

1. A thermal interface material, comprising:
a plurality of thermally conductive, malleable fibers arranged in a pattern, the fibers of the pattern in contact with each other, when compressed against a first surface.

2. The thermal interface material of claim 1, further comprising:
a thermal medium, the medium encompassing the fibers, the thermal medium being malleable and deforming to fill irregularities when the fibers are compressed against a first surface.

3. The thermal interface material of claim 1, wherein the fibers include one of the following: a metal, a metal compound, or a metal alloy.

4. The thermal interface material of claim 1, wherein the fibers are a non-metal.

5. The thermal interface material of claim 4, wherein the non-metal includes carbon or graphite.

6. The thermal interface material of claim 1, further comprising:
an adhesive applied to the fibers, the adhesive affixing the fibers in position on a first surface until the fibers are compressed against the first surface.

7. The thermal interface material of claim 1, wherein the pattern includes a random pattern.

8. The thermal interface material of claim 1, wherein the pattern includes a stacked pattern.

9. The thermal interface material of claim 1, wherein the pattern includes a woven pattern.

10. A method, comprising:
providing a plurality of thermally conductive, malleable fibers in a pattern;
positioning the plurality of fibers between a first surface and a second surface; and
compressing the plurality of fibers between the first and second surfaces, the compression deforming the fibers into contact with each other and into contact with the first surface and second surface.

11. The method of claim 10, wherein the first surface is a thermal plate and wherein the second surface is a heat source.

12. The method of claim 10, wherein the pattern includes a random pattern.

13. The method of claim 10, wherein the pattern includes a stacked pattern.

14. The method of claim 10, wherein the pattern includes a woven pattern.

15. The method of claim 10, further comprising:
encompassing the fibers in a thermal medium, the thermal medium being malleable, the thermal medium deforming to fill irregularities when compressed against a first surface.

16. The method of claim 10, wherein the fibers include one of the following: a metal, a metal compound, a metal alloy.

17. The method of claim 10, wherein the fibers are a non-metal.

18. The method of claim 17, wherein the non-metal includes carbon or graphite.

19. The method of claim 10, further comprising:
applying an adhesive to the fibers to affix the fibers in position on the first surface until the fibers are compressed against the first surface.

20. An apparatus, comprising:
a plurality of thermally conductive, malleable fibers defining a pattern positioned against a first surface; and
means for compressing the plurality of fibers between the first surface and second surface, the compression deforming the fibers into contact with each other and with said first surface and said second surface.

21. The apparatus of claim 20, wherein the first surface is a thermal plate and wherein the second surface is a heat source.

22. The apparatus of claim 20, wherein the fibers are encompassed in a thermal medium. The medium acting and being malleable, the thermal medium deforming to fill irregularities when the fibers are compressed against the first surface.

23. The apparatus of claim 20, wherein the fibers include one of the following: a metal, a metal compound, or a metal alloy.

24. The apparatus of claim 20, wherein the fibers are a non-metal.

25. The apparatus of claim 20, wherein the non-metal includes carbon or graphite.

26. The apparatus of claim 20, wherein the pattern includes a random pattern.

27. The apparatus of claim 20, wherein the pattern includes a stacked pattern.

28. The apparatus of claim 20, wherein the pattern includes a woven pattern.
